(19) United States
(12) Patent Application Publication
(10) Pub. No.: US 2011/0089605 A1
(43) Pub. Date: Apr. 21, 2011

(54) Method for manufacturing biodegradable cinerary urns

(75) Inventors: Jorge Requena Olcina, Barcelona (ES); Moisés Diaz Ferrando, Barcelona (ES)

(73) Assignee: LIMBO DISSENY, S.L.

(21) Appl. No.: 12/806,959

(22) Filed: Aug. 25, 2010

Related U.S. Application Data
(63) Continuation-in-part of application No. 12/221,468, filed on Jul. 31, 2008, now abandoned.

(30) Foreign Application Priority Data
Jul. 31, 2007 (ES) P200702146

(51) Int. Cl. B29C 70/02

(52) U.S. Cl. 264/241

(57) ABSTRACT

A method that comprises the use of materials selected from amongst aggregates, aromatic plants, vegetal organic matter, plant earth, beach sand, marine salt, and combinations thereof, that are then mixed with vegetal agglutinant agents and the resulting mixture poured inside molds that are subjected to a pressure treatment and then, once they have had time to dry, to a heat application which purpose is to consolidate the urn (1). In addition, the method comprises incorporating a coating (7) selected from amongst aromatic plants, a layer of dyes, sheets of precious metals and combinations of these elements. Because the urn is of a biodegradable nature, it does not have a harmful effect of the environment when it is disposed of as waste.

This is a continuation-in-part of U.S. patent application Ser. No. 12/221,468.

The present invention refers to a process to manufacture biodegradable cinerary urns intended to hold the ashes resulting from incinerating a corpse and the object of which is allowing the combination of different biodegradable materials using vegetal agglutinants as binding means.

One object of the invention is to include aromatic plants as part of the biodegradable ingredients, so the urn can emit pleasant aromas and even work as air freshener.

Another object of the invention is to include an improved urn lid that may be made from different materials, including live materials such as a plant or similar.

### BACKGROUND OF THE INVENTION

Biodegradable urns are designed to contain the ashes resulting from incinerating a corpse to be later thrown into the ocean or buried in the ground in a manner that does not generate waste when they are disposed of in any of the above manners.

In this sense an example can be found in the Spanish patent of invention No. ES2166705B2 describing a body and its corresponding lid made of jelly obtained from the partial acid or basic hydrolysis of collagen.

In the same sense the Utility Model No. ES1060012U provides an example for the same. It describes an urn that as in the previous example comprises a container and a corresponding lid made of biodegradable cellulose.

Both cited documents describe the use of different biodegradable materials to configure the urn, but do not, for instance, disclose the use of aromatic biodegradable materials to make the urn more pleasant for the user.

### DESCRIPTION OF THE INVENTION

To attain the objectives and solve the disadvantages stated above, the present invention has developed a new method for manufacturing biodegradable cinerary providing the use of materials selected from amongst aggregates, aromatic plants, vegetable organic matter, plant earth, beach sand, marine salt, or any combination thereof, also contemplating mixing said materials with vegetal agglutinant agents. The agglutinant of choice in the preferred embodiment of the invention is rice starch.

The method of the invention refers to the use of approximately 150 grams of said agglutinant agents per each kilogram of aggregate used in making the urn.

Once the described materials have been mixed aided by the agglutinant, the resulting mixture is poured into molds that are subjected to pressure treatment and after they have had time to dry they are subject to a heat treatment which function is to consolidate the structure of the urn.

The method of the invention comprises a coating phase in which aromatic plants, a dye and/or sheets of precious metal are incorporated to the urn.

The shape of the urn is spherical and has a lid with two parallel slits through which a ribbon is threaded to form a handle loop that serves as lid handle to facilitate the opening and closing operations.

In one of the embodiments of the invention said lid will be a live plant that can grow and develop by feeding on the materials that constitute the urn when it comes in contact with a source of humidity.

The next section, which is an integrated part of the present specification, contains a description of the figures provided to facilitate the understanding of same and which function is merely illustrative and not limitative of the object of the present invention.

In a preferred embodiment of the invention, the process comprises the use of marine salt as the material making up the urn. Optionally, a small amount of starch, particularly, rice, yucca or corn starch may be present. In case of yucca starch the amount thereof will be of 10% by weight. The advantages of manufacturing the urn with marine salt is that the urn will be very hard and at the same time it is easily soluble when put in contact with water. The pressure applied in the process is of about 12,000 kg and the drying temperature is of about 105° C.

Therefore a preferred embodiment of the method is a method for manufacturing biodegradable cinerary urns, comprising mixing marine salt with a 10% by weight of a starch selected from the group consisting of rice starch, yucca starch and corn starch as agglutinant agent, obtaining a mixture,

pouring the mixture of the previous step into molds,

subjecting the molds to pressure, preferably of 12,000 kg

drying, preferably at 105° C., and consolidating the urn (1) by means of a heat application treatment.

This process guarantees the obtaining of a spherical urn.

Due to the high hygroscopicity of the salt, the urn must be kept in a dry environment, to preserve its properties until it is used.

### BRIEF DESCRIPTION OF THE FIGURES

FIG. 1.—Shows a perspective view of a possible example of an embodiment of the urn object of the invention in which the lid is shown in an exploded view.

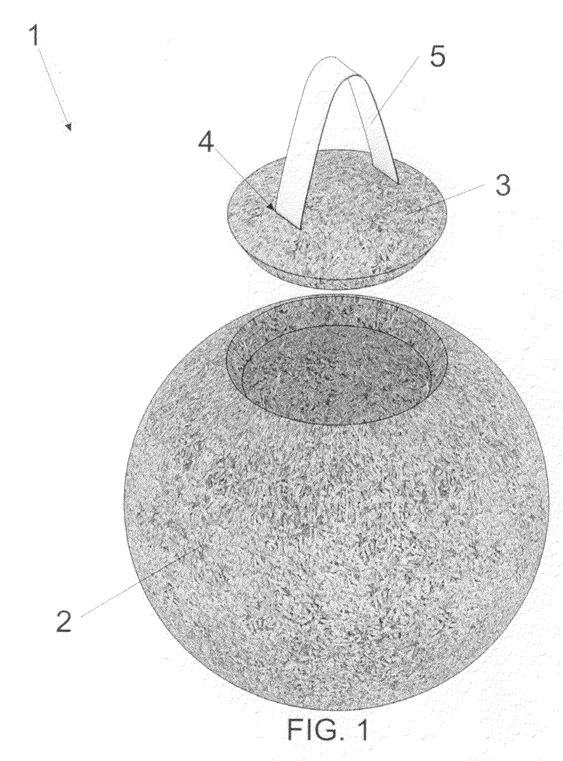

FIG. 2.—Shows a section view of the same urn shown in the previous figure with the lid assembled and a detail of the thickness of the urn as composed by the biodegradable materials used according to the specifications of the invention.

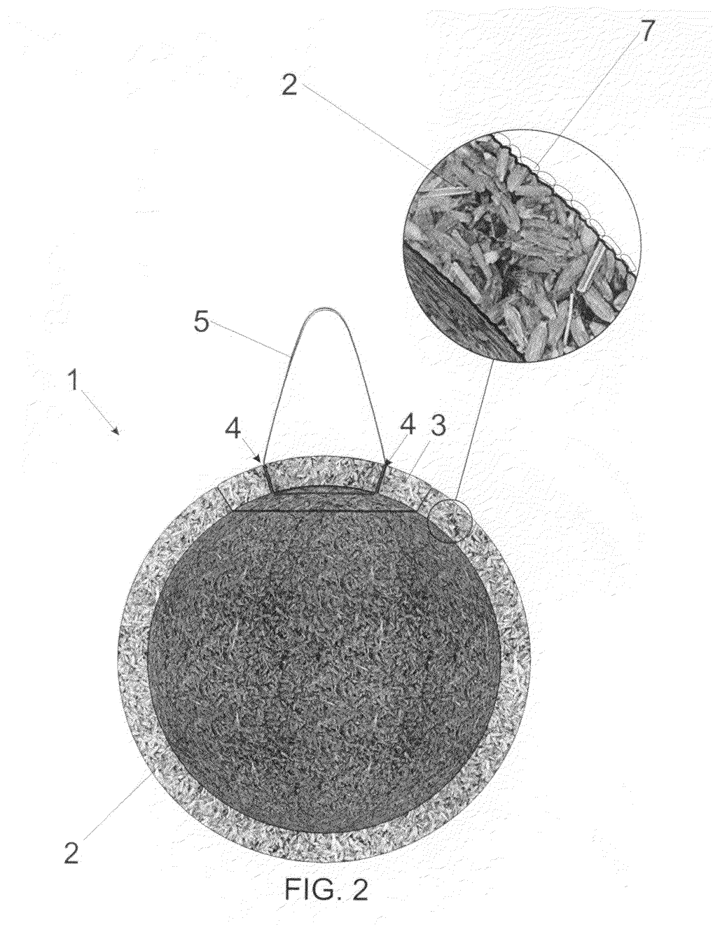

### DESCRIPTION OF THE PREFERRED EMBODIMENT OF THE INVENTION

This section contains a description of the invention based on the figures described on the previous section.

The urn 1 object of the present invention comprises a spherical container 2 stoppered by a lid 3 that closes the spherical configuration and has the particularity of having been obtained through a manufacturing procedure in which aggregates and aromatic plants or vegetal organic material have been mixed. In any case the mixture is achieved by using vegetal agglutinant agents, preferably rice starch, as binders. For the mix containing aggregate materials, the manufacturing method of the invention comprises the use of approximately 150 grams of said agglutinant agent per each kilogram or sand or earth used in the mixture.

After the paste has been obtained it is poured into molds and is shaped by applying pressure. The next step is to let it dry and later apply heat to consolidate the obtained structure.

After the urn's structure has the desired consistency the external side is decorated with a coating 7 of aromatic plants and/or dyes and sheets of precious metals.

The lid 3 has two parallel slits 4 through which a ribbon 5 is threaded to form a handle loop and serve as lid handle and facilitate the opening and closing operations.

The lid 3 may be substituted by a live plant that can develop and grow by feeding on the materials that make up the urn 1 when it comes in contact with a source of humidity which occurs by a natural process when the urn is placed on the ground and comes in contact with the released humidity.

1. Method for manufacturing biodegradable cinerary urns, wherein it comprises using materials selected from the group consisting of aggregates, aromatic plants, vegetal organic matter, plant earth, beach sand, marine salt and combinations thereof bound by means of vegetal agglutinant agents.

2. Method for manufacturing biodegradable cinerary urns, according to claim 1, wherein the vegetal agglutinant agent is rice starch.

3. Method for manufacturing biodegradable cinerary urns, according to claim 2, wherein 150 grams of said agglutinant agent is used per each kilogram of aggregate material used.

4. Method for manufacturing biodegradable cinerary urns, according to claim 1, wherein the obtained mixture is poured into molds, then is subjected to a pressure treatment and then is left for drying and then by means of a heat application treatment, the structure of the urn (1) is consolidated.

5. Method for manufacturing biodegradable cinerary urns, according to claim 4, wherein the urn is covered with a coating (7) selected from the group consisting of aromatic plants, a layer of dyes, sheets of precious metals and combinations thereof.

6. Method for manufacturing biodegradable cinerary urns, according to claim 1, wherein the urn comprises a spherical container (2) equipped with a lid (3).

7. Method for manufacturing biodegradable cinerary urns, according to claim 6, wherein the lid (3) is provided with two parallel slits (4) through which a ribbon (5) is threaded to define a handle loop in order to facilitate its handling.

8. Method for manufacturing biodegradable cinerary urns, according to claim 6, wherein the lid (3) is a live plant.

9. Method for manufacturing biodegradable cinerary urns, according to claim 1, comprising
using marine salt with a 10% by weight of a starch selected from the group consisting of rice starch, yucca starch and corn starch as agglutinant agent, obtaining a mixture,
pouring the mixture of the previous step into molds,
subjecting the molds to pressure,
drying and consolidating the urn (1) by means of a heat application treatment.

10. Method for manufacturing biodegradable cinerary urns, according to claim 9, wherein the pressure is of 12,000 kg and the drying is carried out at 105° C.
